(19) United States
(12) Patent Application Publication
(10) Pub. No.: US 2006/0231323 A1
(43) Pub. Date: Oct. 19, 2006

(54) Steering gear for a motor vehicle

(76) Inventors: Albrecht Rosenfeld, NURTINGEN (DE); Dieter Lechner, Düsseldorf (DE); Uwe Mauz, Esslingen (DE)

Correspondence Address: Robert W Becker & Associates, Suite B, 707 Highway 66 East, Tijeras, NM, 87059, US

(21) Appl. No.: 10/567,597

(22) PCT Filed: Jun. 25, 2004
(86) PCT No.: PCT/EP04/06867

§ 371 Date: Feb. 3, 2006

(30) Foreign Application Priority Data
Aug. 5, 2003 (DE) 103 36 628.8

(51) Int. Cl. B62D 5/06

(52) U.S. Cl. 180/428

(57) ABSTRACT

A steering mechanism comprising a housing, a rack, which defines an axial direction and meshes with a pinion, and a hydraulic servo-drive having a piston/cylinder unit comprising a cylinder, a piston, and a piston rod that extends in the axial direction. The rack is coupled to the cylinder or piston rod, and the rack and piston rod are parallel to one another in the axial direction and are spaced apart from one another in a direction transverse to the axial direction.

The present invention relates to a steering gear or mechanism for a motor vehicle having the features of the preamble of claim 1.

Generic gear-rod servo-steering systems are constructed in such a way that a steering housing is arranged, in its installation position, transversely in the vehicle and that, in this steering housing, a gear rod or rack is also mounted so as to be displaceable in the transverse direction of the vehicle. On the one hand, the gear rod is driven via a steering wheel and a steering column comprising a steering pinion, which meshes with the gear rod. On the other hand, a servo-drive, which comprises a piston/cylinder unit and also acts directly on the gear rod, is arranged laterally set apart from the point at which the pinion engages with the gear rod. The gear rod is conventionally in one piece.

In the case of generic servo-steering systems, the output to the steered wheels takes place via track or tie rods, which are articulated to the end faces of the gear rod via ball-and-socket joints. In some cases, what is known as a center take-off, in which the track rods are articulated in the central region of the steering gear, is also provided.

In numerous new developments of motor vehicles, a fundamental requirement for design engineers is to make the available internal space as large as possible, given the predetermined overall dimensions. In order to achieve this object, the basic components of the motor vehicle have to be as compact as possible in their construction. However, efforts to make conventional gear-rod servo-steering systems more compact are hindered by the fact that, in the case of one-piece gear rods, in which the gear-rod part and hydraulic part are arranged coaxially next to one another, the length of the gear rod, with the hydraulic drive arranged thereon, has to correspond to at least six times the stroke of the steering system in one direction. In addition, there is the travel path of the gear rod, which, in the designing of the motor vehicle, is to be regarded as free space.

The object of the present invention is therefore to provide a new steering gear assembly, which, while having the advantages of a hydraulic gear-rod servo-steering system, allows particularly compact dimensions.

This object is achieved by a steering gear having the features of claim 1.

Because the gear rod and the piston rod are arranged parallel to one another in the axial direction and are spaced apart from one another transversely to the axial direction, the overall space required is reduced in the axial direction. This enables motor vehicle design engineers, who have to allow for fewer spatial constraints when fitting the steering system, to achieve the desired advantages.

Preferably, the gear rod is rigidly connected to the piston rod in the axial direction, thus ensuring enforced coupling between both components. Preferably, the cylinder is connected to the steering housing.

The cylinder may hold the rotary slide valve, so that the required components, which, in terms of their construction, are substantially identical to a conventional gear-rod steering system, are arranged in proximity to the cylinder.

In one embodiment, the free ends of the gear rods are encased by cup-shaped sleeves, which enclose and outwardly seal the required movement space of the gear rod. They may also be encased by sliding sleeves or bellows, which are capable of clearing or freeing the free space that is axially next to the gear rod, for example for a wheel turn.

It may be possible to fasten the rotary slide valve as a module to the left or right-hand side of the frame, so that almost all of the components may be identical, in terms of their construction, for right and left-hand-drive vehicles.

In another embodiment, it may also be provided that the gear rod is rigidly connected to the cylinder in the axial direction. In this case, the cylinder is moved along with the gear rod, while the piston rod is mounted substantially immovably with respect to the vehicle. The rotary slide valve may be fixed to the frame and piston rod, while the cylinder and gear rod are mounted so as to be displaceable relative thereto.

The hydraulic liquid for actuating the servo-drive may expediently be supplied via the end faces (free ends) of the piston rod. A center take-off for the track rods to be actuated may be fastened directly to the cylinder, thus further promoting a compact construction.

In a third embodiment, in total three parallel, axially spaced-apart rods, namely a gear rod, a piston rod and a guide rod, are provided.

In the embodiments in which the cylinder is fixed to the frame, the track rods may be articulated to the end faces of the piston rod.

Embodiments of the present invention will be described below with reference to the drawings, in which:

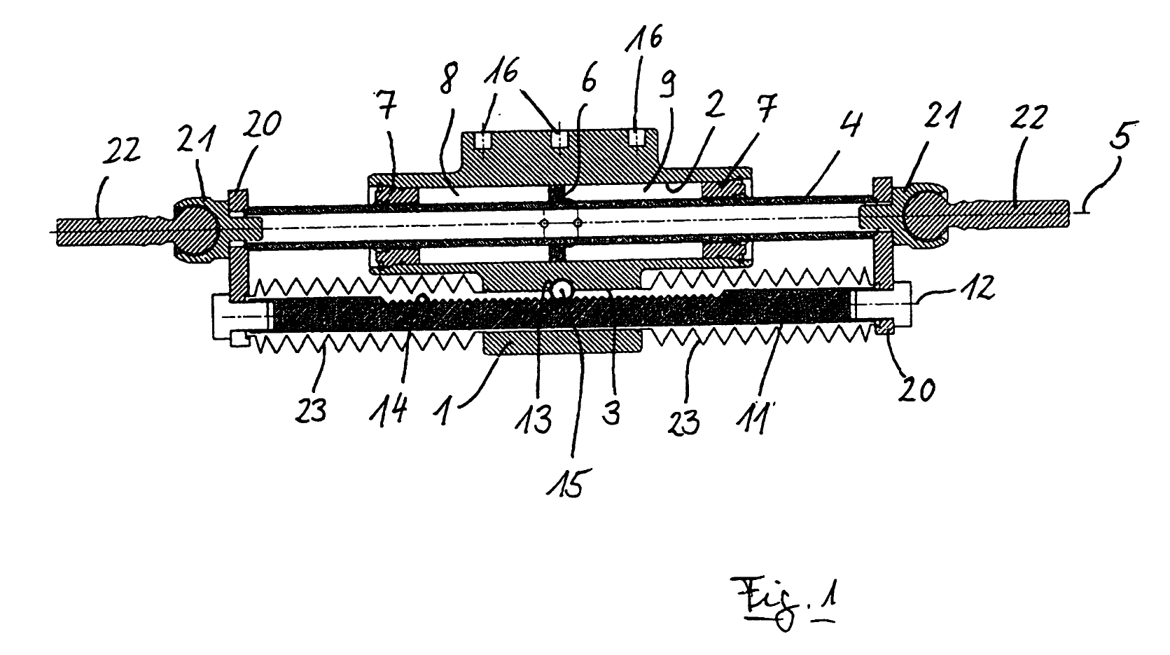

FIG. 1 is a cross section from above of a steering system according to a first embodiment, the gear rod and piston rod being coupled;

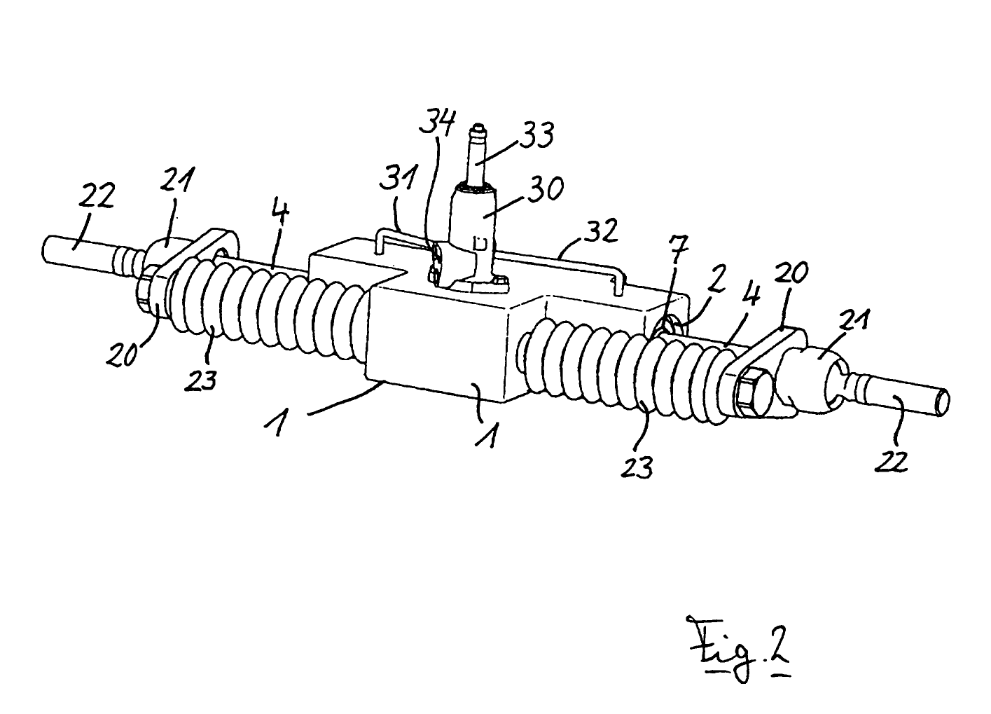

FIG. 2 is a perspective illustration of the steering system according to FIG. 1;

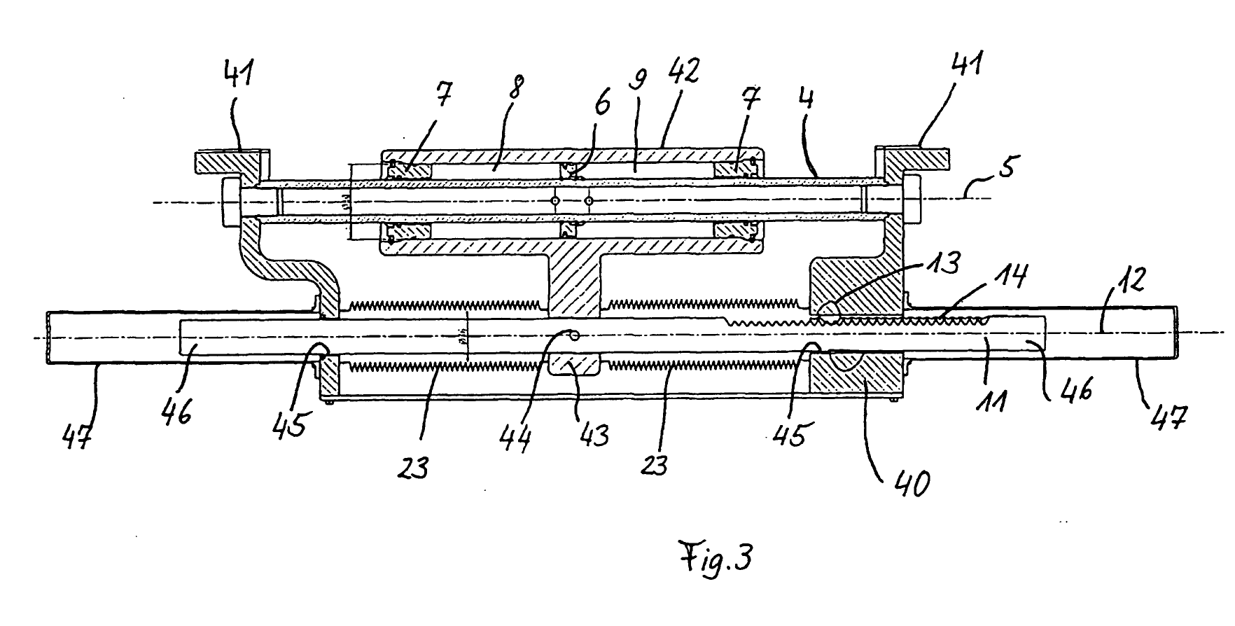

FIG. 3 is a cross section from above of a steering system according to a second embodiment, the gear rod and cylinder being coupled;

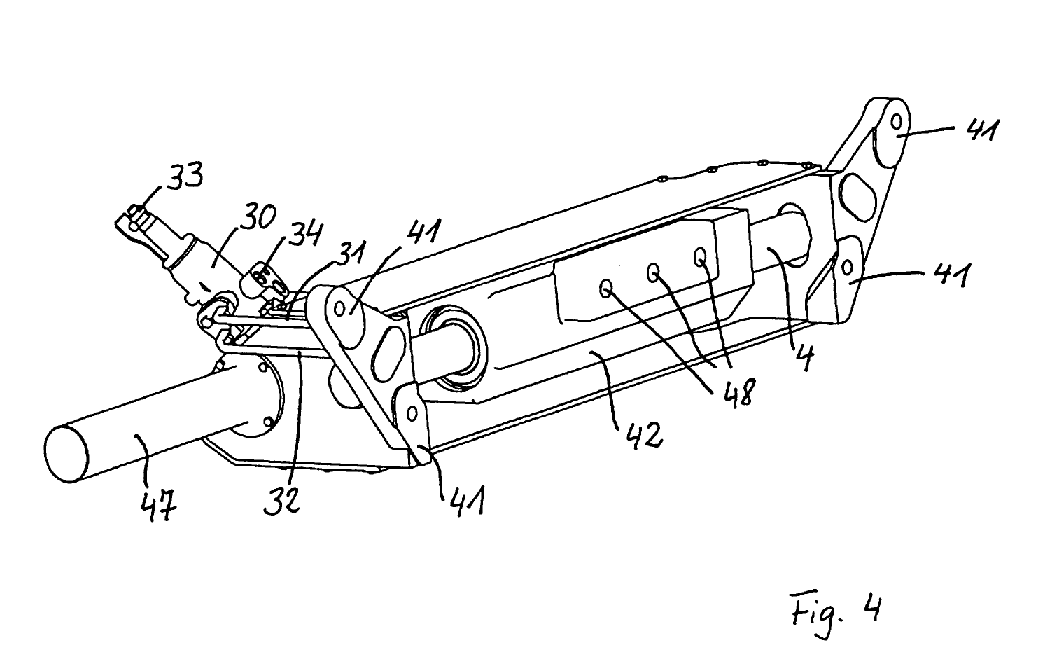

FIG. 4 is a perspective illustration of the steering system according to FIG. 3; and

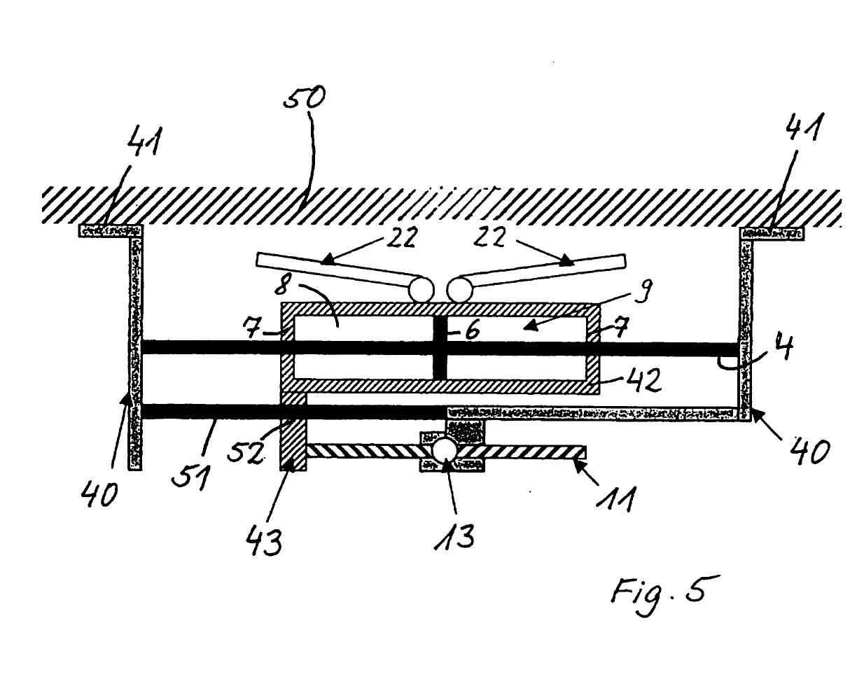

FIG. 5 is a schematic illustration, in plan view, of a third embodiment comprising a separate guide rod.

FIG. 1 illustrates a first embodiment of a steering gear or mechanism according to the invention. The steering gear comprises a steering housing 1, which comprises a cylinder bore 2, extending in the transverse direction of the steering housing, and a gear-rod or rack bore 3 extending parallel to the cylinder bore 2. A piston rod 4 is arranged in the cylinder bore 1 so as to be displaceable in the direction of the axis 5 of the bore. The piston rod 4 holds at its center a hydraulic piston 6, which, in conjunction with the bore 2 and two end-face guiding and sealing elements 7, delimits a left-hand working chamber 8 and a right-hand working chamber 9.

A gear rod or rack 11 is arranged in the gear-rod bore 3 so as to be longitudinally displaceable along the axis 12 of the gear rod. The axis 12 of the gear rod extends parallel to the axis 5 of the bore. The steering housing 1 also holds a pinion 13, which meshes with a toothed portion 14 of the gear rod 11 and which is mounted in the steering housing 1 so as to be rotatable about an axis of rotation 15 oriented perpendicularly to the drawing plane.

On its side opposing the gear-rod bore 3, the steering housing 1 has in total three tapped bores 16, which are used for fastening the steering housing to the frame of a motor vehicle.

The piston rod 4 and the gear rod 11 are interconnected in the region of their free ends via a respective end plate 20. The end plates 20 couple the two components in such a way that they cannot shift relative to one another in the axial direction, i.e. in the direction of the axes 5 and 12. The piston rod 4 also holds at both free ends a respective ball cup 21, which, in turn, holds, in each case, a track or tie rod 22 mounted therein. Finally, the track rods are connected, during the installation of the steering system in the motor vehicle and during operation, to the stub axles or axle spindles of the steered wheels of the motor vehicle in such a way that actuation of the steering system causes the steered wheels to swivel.

Finally, bellows 23, which surround and outwardly seal the free ends of the gear rod 11 outside the bore 3, are associated with the gear rod 11. Soiling of the teeth 14, which might cause, on the one hand, wear and corrosion and, on the other hand, locking of the engagement between the pinion and the teeth 14, is thus prevented in a manner known per se. Advantageously, the engagement of the pinion 13 with the teeth 14 does not have to close the bore 3 in an air-tight manner, so that a volume compensation between the bellows 23 may take place, on axial movement of the gear rod 11, through the bore 3, and a separate means for ventilating or de-ventilating the bellows 23 does not have to be provided.

FIG. 2 is a perspective illustration of the steering system according to FIG. 1. Identical components have identical reference numerals.

As may be seen, a rotary slide valve 30, which is known per se and from which hydraulic lines 31, 32 lead to the working chambers 8, 9, is arranged on the upper side of the steering housing, above the pinion 13. The rotary slide valve 30 comprises a toothed rotary slide 33, which is also to be connected in a conventional manner to a steering column (not shown) of the motor vehicle.

The servo-steering system thus described is installed in that the steering housing 1 is attached, in the region of the tapped bores 13, approximately centrally in the region of the steered axle of a motor vehicle, the axes 5 and 12 being arranged in the transverse direction of the motor vehicle, i.e. horizontally and transversely to the direction of travel. The track rods 22 are connected to the stub axles of the steered wheels. The rotary slide valve 30 is connected, in the region of connection bores 34, to a hydraulic pump and a return means. Finally, the rotary slide 33 is rotationally engaged with a multi-tooth clamping means of a steering column.

If, during operation, the driver of a motor vehicle equipped with the described steering system produces on a steering wheel, via the steering column, an angle of rotation corresponding to a desire to change the direction of travel, the rotary slide 33, and therefore also the pinion 13, is rotated in a manner known per se. A hydraulic stream is introduced into the lines 31 or 32 in accordance with the direction of rotation, so that the pressure in the working chamber 8 or 9 is increased. The pinion 13 causes the gear rod 11 to be displaced in the transverse direction, this movement taking place via the end plates 20 synchronously with a corresponding movement of the piston rod 4 and the track rods 22. The hydraulic pressure in one of the two working chambers assists this movement in the manner of a conventional gear-rod servo-steering system.

This construction has the advantage over conventional steering systems that the toothed portion 14 or the overall gear rod 11 is not arranged coaxially to the piston rod 4. The overall space in the transverse direction, i.e. in the direction of the axis 5, is thus reduced, so that this steering system requires fewer restrictions in its arrangement in the motor vehicle. The fact that the external pressure compensation in the two bellows 23 may be dispensed with is a further advantage. Finally, the installation of this steering system is simpler and procedurally safer because the gear rod 11, which is relatively sharp-edged in the toothed region 14, does not have to be introduced into the region of the hydraulic seals of the end pieces 7. Damage to these seals during the installation process is thus reliably ruled out.

FIG. 3 illustrates another embodiment of a steering system according to the invention. The illustration corresponds to the view according to FIG. 1. Again, identical components have identical reference numerals.

In this embodiment, a steering housing 40 is provided with two fastening regions 41. The steering housing 40 holds the piston rod 4 in a fixed and non-displaceable manner in that the piston rod 4 is screwed to the steering housing 40 in proximity to the fastening regions 41. In this case, too, the piston rod 4 holds a hydraulic piston 6, which, in conjunction with a cylinder 42, delimits two working chambers 8 and 9. On its side facing the gear rod 11, the cylinder 42 comprises a bridge 43, which is screwed tightly to the gear rod 11 in a tapped bore 44. The gear rod 11 is, in turn, mounted in two slide bearings 45 in the steering housing 40 so as to be axially displaceable.

In this embodiment, the gear rod 11 comprises two free ends 46, which are encased by solid, cup-shaped sleeves 47 for protection against environmental influences.

FIG. 4 is a further perspective illustration of the embodiment according to FIG. 3. In this illustration, it may be seen that the pinion 13 is part, just as it is in the first embodiment, of a rotary slide assembly 30, 33. It may also be seen that, in this embodiment, the cylinder 42 holds a flange comprising tapped bores 48, to which track rods (not shown in greater detail) may be screwed during the installation process.

In practice, the steering system according to this embodiment is screwed to the frame of the motor vehicle in the region of the connection flanges 41. The track rods, which lead to the steered wheels, are screwed to the cylinder 42, using a corresponding articulated part, in the region of the bores 48. On rotation of the pinion 13, the gear rod 11 is displaced, via the engagement of the pinion with the toothed region 14, in the transverse direction, i.e. in the direction of the axis 12. As a result of the rigid fastening of the gear rod 11 to the cylinder 42, via the bridge 43, the cylinder is also moved in the transverse direction, while the piston rod 4 rests relative to the steering housing 40, and thus relative to the frame of the motor vehicle. A hydraulic control signal, resulting from the rotation of the rotary slide valve 30, is forwarded to the working chambers 8 and 9 via the hydraulic lines 31 and 32, to ensure servo-assistance by means of an increase in pressure in the respective working chamber. In this way the hydraulic fluid from the lines 31 and 32 may advantageously be supplied via the interior of the piston rod 4.

In terms of its construction, this embodiment also has the advantage that the gear rod 11 and the piston rod 4 are spaced apart from one another in the radial direction and are not arranged coaxially next to one another in the transverse direction of the motor vehicle. The overall space required in the transverse direction is significantly reduced as a result of this arrangement. Furthermore, in this embodiment, it is extremely simple to provide a center take-off in the region of the tapped bores 48.

Since the steering housing and the components, in particular the rotary slide and gear rod, allow a largely modular construction, the modifications required for the two variants, right-hand drive/left-hand drive, are also only minor.

Finally, FIG. 5 is a schematic illustration, corresponding to the views of FIG. 1 and FIG. 3, of a third embodiment.

In this embodiment, a steering housing 40 is screwed to a frame 50 in the region of flanges 41. The steering housing 40 holds the piston rod 4, on which the cylinder 42 is displaceably arranged. The construction of the cylinder 42 substantially corresponds to that from FIG. 3. However, the bridge 43 to the gear rod 11 is attached eccentrically to the cylinder 42. In contrast to the foregoing embodiments, an additional guide rod 51, which is arranged in a guide slide bearing 52 to absorb tilting moments occurring on the bridge 43, is provided parallel to the piston rod 4 and the gear rod 11. As a result of this construction, the gear rod 11 is not subjected to tilting moments. The length of the gear rod 11 may therefore substantially be limited to the stroke of the steering gear, whereas in the embodiments according to FIGS. 1 to 4 the length of the servo-steering system is greater.

During operation, this steering gear operates in accordance with the above-described construction. A torque introduced on the pinion 13 causes displacement of the gear rod 11 in the transverse direction. The gear rod 11 entrains the cylinder 42 via the bridge 43. The track rods 22, which are arranged on the cylinder 42 in a center take-off construction, forward the motion to steered wheels (not shown) of a motor vehicle. A rotary slide valve, which is connected to the pinion 13, produces a hydraulic stream, which provides servo-assistance substantially proportional to the torque introduced on the steering wheel, into one of the two working chambers 8 or 9. Tilting moments are absorbed in the slide bearing 52 and forwarded to the frame of the motor vehicle 50 via the guide rod 51 and the steering housing 40. The piston rod 4 and the guide rod 51 are rigidly connected to the steering housing 40, while the gear rod 11 is movable in the transverse direction. These three components are spaced apart from one another in the axis-parallel and radial directions.

The third embodiment is illustrated purely schematically in FIG. 5. The precise configuration will be similar to that in the embodiments according to FIGS. 1 to 4.

1-13. (canceled)

14. A steering mechanism comprising:
a housing;
a rack, which defines an axial direction and meshes with a pinion; and
a hydraulic servo-drive having a piston/cylinder unit comprising a cylinder, a piston, and a piston rod that extends in said axial direction, wherein said rack is coupled to said cylinder or said piston rod, and wherein said rack and said piston rod are parallel to one another in said axial direction and are spaced from one another in a direction transverse to said axial direction.

15. A steering mechanism according to claim 14, wherein said rack is fixedly connected with said piston rod in said axial direction.

16. A steering mechanism according to claim 14, wherein said cylinder is connected to said housing.

17. A steering mechanism according to claim 14, wherein said cylinder carries a rotary slide valve.

18. A steering mechanism according to claim 14, wherein free ends of said rack are encased by sleeves that enclose and outwardly seal a movement space of said rack.

19. A steering mechanism according to claim 14, wherein free ends of said rack are encased by sliding sleeves or bellows that are adapted to free a space that is disposed axially adjacent to said rack.

20. A steering mechanism according to claim 14, wherein a modular rotary slide valve is eccentrically secured to a frame that carries said steering mechanism.

21. A steering mechanism according to claim 14, wherein said rack is fixedly connected to said cylinder in said axial direction.

22. A steering mechanism according to claim 14, which is provided for a vehicle, and wherein said piston rod is mounted so as to be substantially unmovable relative to the vehicle.

23. A steering mechanism according to claim 14, wherein a center take-off for tie rods that are to be actuated by said steering mechanism is secured directly to said cylinder.

24. A steering mechanism according to claim 14, which includes means for supplying hydraulic fluid to end faces of said piston rod for actuating said servo-drive.

25. A steering mechanism according to claim 14, which includes a guide rod, and wherein said guide rod, said rack, and said piston rod are parallel to and axially spaced from one another.

26. A steering mechanism according to claim 14, wherein tie rods are articulated to end faces of said piston rod.
